(19) United States
(12) Patent Application Publication
(10) Pub. No.: US 2012/0038716 A1
(43) Pub. Date: Feb. 16, 2012

(54) AEROSOL PRINTER, USE THEREOF, AND METHOD FOR PRODUCING LINE INTERRUPTIONS IN CONTINUOUS PRINTING METHODS

(75) Inventors: Matthias Hoerteis, Hanau (DE); Aleksander Filipovic, Freiburg (DE); Christian Seitz, Markgroeningen (DE)

(73) Assignee: Fraunhofer-Gesellschaft Zur Foerderung Der Angewandten Forschung E.V., Munich (DE)

(21) Appl. No.: 13/138,322

(22) PCT Filed: Feb. 2, 2010
(86) PCT No.: PCT/EP2010/000627

§ 371 Date: Oct. 17, 2011

(30) Foreign Application Priority Data
Feb. 6, 2009 (DE) 10 2009 007 800.2

(51) Int. Cl. B41J 2/215

(52) U.S. Cl. 347/83

(57) ABSTRACT

The invention relates to an aerosol printer which has at least one atomising chamber and at least one printing head with at least one nozzle, these being connected directly or via connection lines. Furthermore, the aerosol printer has process gas-, transport gas- and focusing gas lines.

The invention relates to an aerosol printer which has at least one atomising chamber and at least one printing head with at least one nozzle, these being connected directly or via connection lines. Furthermore, the aerosol printer has process gas-, transport gas- and focusing gas lines. The aerosol printer thereby enables interruption of the aerosol transport from the atomising chamber to the nozzle. The invention likewise relates to a method for producing line interruptions with a continuous aerosol printing method using the aerosol printer according to the invention. The aerosol printer according to the invention is used in particular for printing patterns, e.g. printing metal contacts onto solar cells or other semiconductors.

The aerosol printing technique is best suitable for printing continuous lines. This thereby concerns a printing system in which a continuous flow of ultrasmall ink droplets, the aerosol, is conducted through a nozzle onto the substrate to be printed. Since, unlike a drop-on-demand (DOD) printing system, the aerosol flow flows continuously, it is not possible to switch this off briefly and to start it again with the aim of achieving line interruptions as desired.

This problem has been resolved to date by connecting a mechanical shutter between nozzle and substrate and by defining the line interruption by opening or closing this shutter. Whilst the shutter is closed, the aerosol flows out of the nozzle onto the shutter and is collected by the latter. In order to avoid overflow, the shutter is provided with a suction device.

Provided that the printing system consists of only one nozzle, this is a practicable solution. If the printing head consists of a plurality of parallel nozzles, then the shutter becomes too sluggish because of its mass and small line interruptions are difficult to produce. This mechanical shutter, as used at present, has the further disadvantage of reducing the spacing between shutter and nozzle outlet and hence impairing the stability of the printer-blockage of the nozzle is more possible because of the reduced spacing since it happens that ink drops rebound from the shutter and hence reach the nozzle opening.

The printers known from the state of the art thereby have the following construction.

The aerosol produced in an atomiser is conducted into the printing head and conducted there by means of a gas flow, the focusing gas, into the nozzle or nozzles, focused and finally printed on a substrate. The focusing gas thereby prevents the aerosol from coming in contact with the printing head or the printing nozzle. Between nozzle outlet and substrate, there is a spacing of approx. 2 to 4 mm.

According to the type of atomisation, there are various embodiments of the aerosol printer. If the atomiser method makes high gas flows necessary, the aerosol must be concentrated in addition before it reaches the printing head. This takes place in a so-called gas separator (virtual impactor, VI). A gas separator concerns two oppositely placed nozzles. If the aerosol flow enters the first nozzle, then the former is accelerated and released again during outflow. Average and larger droplets have sufficient impetus, because of their speed and mass, to overcome the gap to the second nozzle. The gas and small drops required for production of the aerosol are deflected because of their smaller impetus and do not reach the opening of the second nozzle. In addition, a low pressure is produced between the two nozzles and the gas and the smaller drops are suctioned off. The aerosol which has reached the second nozzle is far denser and, because of the pressure difference between atomiser and nozzle, is moved in the direction of the nozzle opening. Because of the dimension of the gas separator, the nozzle openings and the spacing, it can be determined which droplet sizes are conducted further in the direction of the printing head and which are suctioned off.

However, a gas separator is only used if a high gas flow is required for the aerosol production. In the case of an aerosol production by means of ultrasound, a gas separator can be dispensed with.

In general, an aerosol printer has two inlets for gas and, according to the construction, two (with gas separator) or one gas outlet. A gas inlet is required in order to produce the aerosol and transport it at the same time, a further is necessary in order to focus it in the nozzle. The system has an opening at the aerosol outlet, the nozzles. In the case of pneumatic aerosol production, the system has a further gas outlet, on the gas separator which reduces the gas flow, necessary for the aerosol production, until it suffices to transport the aerosol in the direction of the nozzle opening. A pressure difference is produced in the system so that the aerosol can flow uniformly in the direction of the nozzles.

The printing image can be changed decisively by changes in the gas flow in the system.

Starting herefrom, it was the object of the present invention to avoid the disadvantages of the described prior art and to provide an aerosol printing method which enables line interruptions and thereby is easy to handle and operates without disruption as far as possible.

This object is achieved by the generic aerosol printer having the characterising features of claim 1 and also by the method for producing line interruptions with a continuous aerosol printing method having the features of claim 13. In claim 20, a use according to the invention is indicated. The further dependent claims reveal advantageous developments.

According to the invention, an aerosol printer is provided, which comprises at least one atomising chamber and at least one printing head with at least one nozzle, the atomising chamber and the printing head being connected directly or via a connection line. Furthermore, the aerosol printer has process gas-, transport gas- and focusing gas lines. The aerosol printer is distinguished in particular by at least one of the gas or connection lines or the printing head having at least one device for reducing or increasing the gas- or aerosol throughflow for interrupting the aerosol transport from the atomising chamber to the nozzle.

The aerosol printer according to the invention is based on a system in which the aerosol is transported continuously in the direction of the nozzle opening. This aerosol flow is defined by the adjusted gas flows and the pressures in the system resulting therefrom. The concept according to the invention is based on interrupting this aerosol flow or stopping it briefly and hence producing line interruptions. This can be achieved by corresponding changes in pressures in the system. By means of slight pressure variations, the continuous aerosol flow can be stopped briefly. For this purpose, 3 different basic variants are possible:
1. The inflow of the transport gas or the process gas is interrupted or diverted.
2. The aerosol transport is interrupted or diverted directly, e.g. by a shutter.
3. The aerosol jet is impeded briefly by a high gas pressure of the focusing gas at the outlet from the nozzle.

These three variants can also be combined with each other.

According to the first variant, the transport gas or the process gas can be diverted briefly by a valve, e.g. in order to direct the gas out of the system, or interruption of the transport gas- or process gas flow is effected. By diverting the process gas or transport gas, the aerosol flow comes to a standstill and a line interruption is the result. If a gas separator is used, it can be sensible also to switch off the latter in parallel to interruption of the gas flows in order to prevent aerosol present in the system being suctioned out. According to the desired line interruption, it is sometimes however also adequate to produce an interruption of the process gas- or transport gas flow alone.

The second variant provides that the pressure in the system is briefly reduced so that the aerosol flow comes to a standstill. Such a temporary opening of the system can be started for example by a ventilation valve either on the printing head or, provided that a gas separator is used, before or after the gas separator. As soon as the ventilation valve is closed again, the pressure required for the printing process can build up in the system and a continuous aerosol flow is again ensured. The aerosol which has flowed up to the opening of the system is either collected or, better, conducted out of the system. The length of the interruption is defined by the duration of the opening in the system. This variant has the advantage, provided that the aerosol is conducted out of the system, that no excess pressure builds up in the system. For particular preference, an interruption in the aerosol flow is directly after production thereof in the atomising chamber or shortly before, in or after the first nozzle of the gas separator. A brief interruption at this point leads not only to standstill of the continuous aerosol flow but also to the aerosol being actively suctioned out in the gas separator. This can lead to the aerosol flow in the printing nozzle being stopped very abruptly. In order to avoid the entire aerosol being suctioned out of the system, which would lead to a long interruption, it can be preferable also to switch off or bypass the gas separator briefly after stoppage of the aerosol flow. The low pressure in the gas separator is thereby produced with a vacuum pump and can be interrupted very rapidly by ventilation of the gas separator being effected via a ventilation valve.

The second variant can however also be configured such that a mechanical shutter within the system interrupts the aerosol flow briefly and hence ensures line interruptions. An aerosol interruption by a mechanical shutter can be effected preferably after the atomising chamber, after the gas separator or inside the printing head.

The third variant is based on the fact that the gas pressure of the focusing gas is greatly increased briefly and hence the aerosol flow is cut off as it were. As a function of the pulse duration, a greater or smaller line interruption is obtained.

All the embodiments according to the invention have in common that an interruption of the aerosol flow is effected in the region between atomising chamber and nozzle outlet of the printing head, whereas, according to prior art, only external interruptions are provided, e.g. a mechanical shutter between nozzle and substrate.

By means of the system according to the invention, any line interruptions are thus possible so that a controllable system which resembles the DOD printing system results from a continuous printing system. The modifications to conventional aerosol printers are easy to effect and have no influence on the stability of the printing process. A further advantage of the aerosol printer according to the invention is that, by means of the latter, considerable costs and resources can be saved.

The subsequent embodiments represent preferred developments of the system.

The device for reducing or increasing the gas- or aerosol throughflow is selected preferably from the group consisting of pressure control valves, multiway valves, pressure regulating valves, throughput control valves, cut-off valves, flow governors, shutters or combinations hereof.

For concentration of the aerosol, the connection line between atomising chamber and printing head is preferably interrupted by a gas separator having a first and a second nozzle.

A further preferred embodiment provides that the aerosol printer has in addition a vacuum pump for suctioning off the gas. This is connected via a suction line to one of the components of the system, i.e. the aerosol printer, the suction line having a valve for interrupting the gas flow or a ventilation valve. It is thereby preferred that the suction line has a valve for interrupting the gas flow or a ventilation valve.

A preferred variant provides that the process gas line has a valve for interrupting or diverting the process gas. In this case, the gas supply to the system is interrupted, as a result of which the aerosol flow to the nozzle is stopped.

A preferred variant provides that the process gas line is divided into a transport gas line and a focusing gas line, the transport gas line having a valve for interrupting or diverting the transport gas.

It is likewise possible that the connection line between atomising chamber and gas separator or the connection line between gas separator and printing head has a valve for interrupting or diverting the aerosol flow or a mechanical shutter.

The gas separator can have a bypass line, the bypass line in turn being able to have a valve for interrupting the gas flow or a ventilation valve.

A further variant provides that the focusing gas line has a device for increasing the gas throughflow, via which the gas flow of the focusing gas is increased relative to the gas flow of the transport gas such that the aerosol transport to the nozzle is interrupted.

All the mentioned variants are independent of the number of nozzles used and have a uniform effect on all lines during use of a plurality of parallel nozzles.

Pneumatic atomisers or ultrasonic atomisers are preferred as atomisers.

According to the invention, a method for producing line interruptions with a continuous aerosol printing method, using an aerosol printer as described previously is likewise provided. A brief interruption to the aerosol transport is hereby effected by specific adjustment of the gas pressure in the gas- or connection lines and/or in the printing head, with the help of at least one device for reducing or increasing the gas- or aerosol throughflow in order to interrupt the aerosol transport from the atomising chamber to the nozzle.

It is hereby preferred that the gas pressure for the supply line of the focusing gas is increased such that, because of the substantially higher gas pressure of the focusing gas relative to the gas pressure of the transport gas, the aerosol transport to the nozzle is interrupted.

Another preferred variant provides that the gas pressure for the process gas line or the transport gas line is reduced, in particular by diversion of the gases via a multiway valve or using a pressure control valve, such that the aerosol transport from the atomising chamber to the nozzle is interrupted.

It is likewise possible that a brief pressure reduction is produced with the help of ventilation valves in the gas- or connection lines, in the printing head and/or in the gas separator, by means of which pressure reduction the aerosol transport to the nozzle is prevented. During the reduction in the gas pressure, preferably the gas separator is thereby switched off in addition.

A further preferred variant provides that the aerosol transport is interrupted by means of a mechanical shutter which is disposed in particular in the transport direction of the aerosol after the atomising chamber, after the gas separator or in the printing head.

The aerosol printer according to the invention is used for printing any patterns in which no continuous structures are desired. There are included herein for example printing of metal contacts on solar cells. In the case of the latter, printing over the edge is undesired, i.e. the metal contact should be interrupted at these places.

The subject according to the invention is intended to be explained in more detail subsequently with reference to the subsequent Figures and examples, without wishing to restrict said subject to the special embodiments shown here.

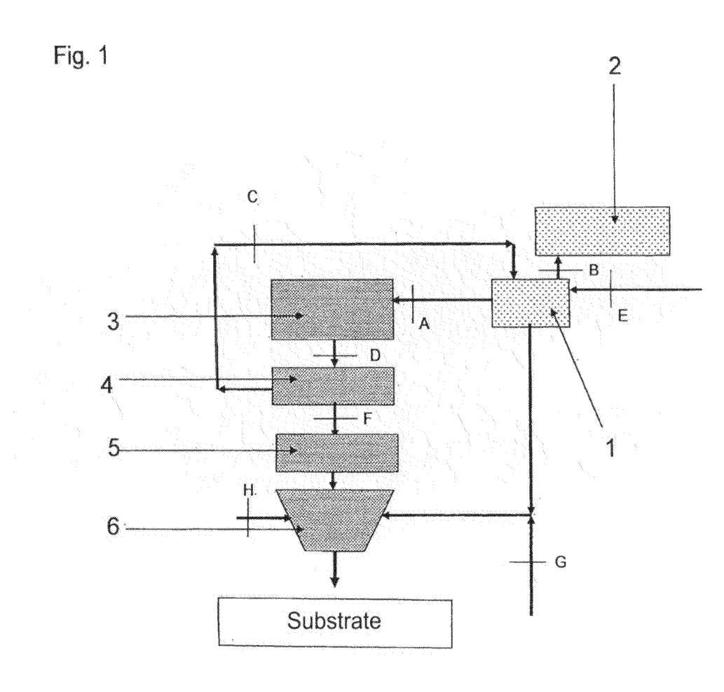

FIG. 1 shows, in a schematic representation, various variants for internal interruption or diversion in the aerosol printer according to the invention for producing line interruptions.

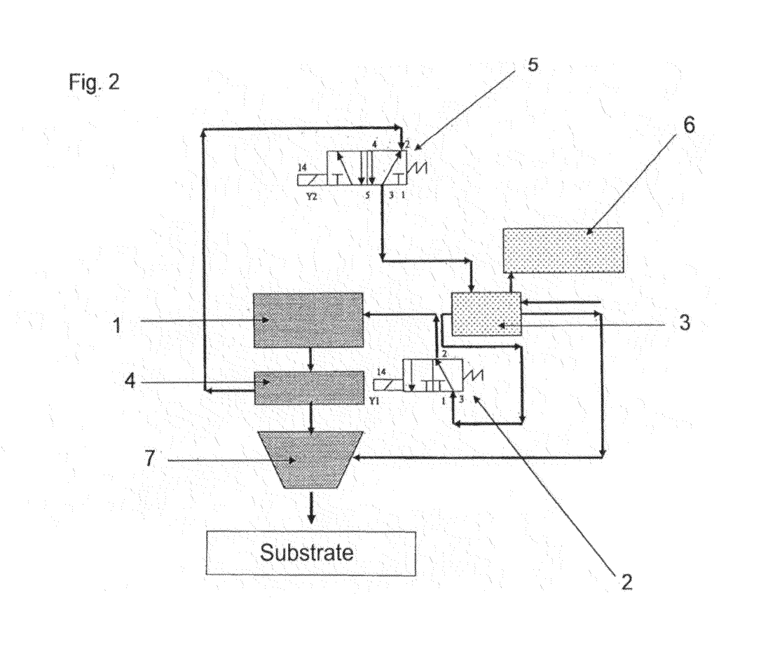

FIG. 2 shows the schematic representation of the implementation according to example 1.

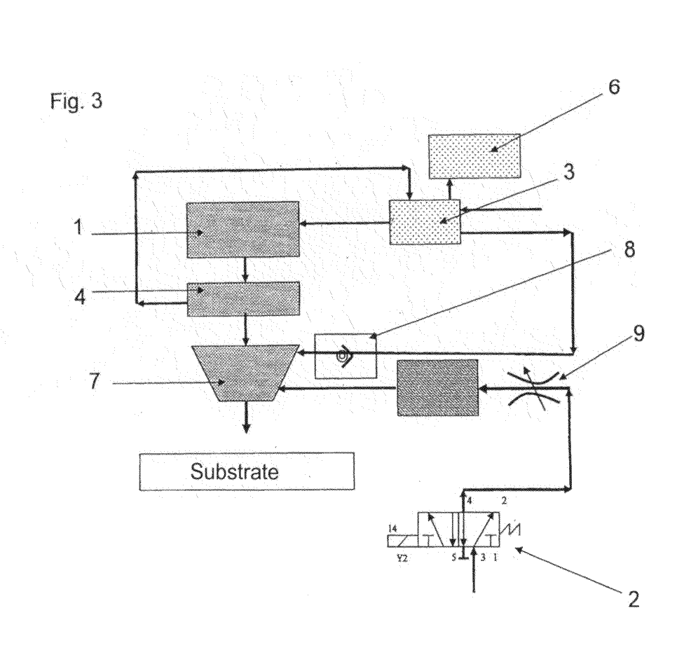

FIG. 3 shows the schematic representation of the implementation according to example 2.

In FIG. 1, various variants for interrupting the aerosol jet are represented.

The first variants 1 to 4 relate to line interruptions based on changes to the process gases.

In the 1^{st} variant, the process gas is interrupted/diverted before the controller 1. As a result, atomisation of the ink no longer takes place, at the same time focusing gas can no longer flow (brief switching off of the gas supply). In the 2^{nd} variant, the line to the vacuum pump is interrupted (ventilated) in addition to switching off/diverting. By means of the additional interruption of the vacuum pump, it is achieved that, in the case of short interruptions to the process gas, the system is not completely evacuated and the start-up would be slowed down. Variant 3 and 4 are designed similarly to variant 1 and 2. However, in the case of interruption/diversion at position A, only the transport gas/atomiser gas is switched off and not the focusing gas. This has the advantage that the nozzles are protected from blockages, even during the interruption, in addition by the focusing gas.

The vacuum can be interrupted or ventilated in variants 3 and 4 at position B and C. When using a shutter, position C is to be preferred and, when using a multiway valve which can be used for the ventilation, position B.

Variants 5 to 8 relate to line interruptions based on gas interruptions or gas diversions in the aerosol flow.

In variants 5 and 6, the aerosol jet is interrupted/diverted at position D, position D is situated between the atomiser 3 and the gas separator 4. In the case of variant 5, only the aerosol jet is interrupted/diverted and, in variant 6, in addition the vacuum is switched off at position C, this would have the advantage that the system at point D is not completely evacuated and, after being switched off briefly, the lines need not firstly be filled again with aerosol.

In variant 7, at position F between gas separator 4, heating tube 5 and printing head 6, the aerosol jet is switched off/diverted and hence interrupted directly in front of the printing head 6.

In variant 8, at the same time as the interruption/diversion at position F, the vacuum at position C is interrupted. By simultaneous switching-off of the suction at position C, too much aerosol is prevented from escaping out of the system and short interruptions consequently not being achievable.

Variants 9 to 11 relate to line interruptions based on pressure increases in the system.

In variant 9 and 10, the focusing gas is increased briefly until silver ink deposition no longer takes place. By increasing the focusing gas in the printing head 6, such a high counter-pressure can be produced at the nozzle that aerosol can no longer flow out of the aerosol tubes. The brief increase in focusing gas can take place directly by increasing the focusing gas at point H.

In variant 9, the increase in focusing gas is achieved by the connection of a second switchable focusing gas connection to the printing head 6. In variant 10, the focusing gas is increased by switching on a second line or by switching over to a second stronger focusing gas line. In variant 11, the volume flow is increased at position G or H, C and A are interrupted at the same time. Hence, it should be achieved that no aerosol is atomised and, at the same time, no aerosol can escape at the nozzles.

### Example 1

In the experimental construction according to FIG. 2, the process gas of the pneumatic atomiser 1 is interrupted and hence no aerosol is produced for the duration of the interruption. This takes place by a 3/2-way valve 2 being incorporated between controller (PCM) 3 and atomiser 1. The valve 2 was connected such that, in the inactivated state, the transport gas can flow from the controller 3 through the valve 2. During switching of the valve, the outflow of the transport gas out of the valve 2 is completely prevented and hence can no longer arrive at the atomiser and hence pneumatic atomising can no longer take place. By means of complete closure of the transport gas line, an excess pressure is built up in the line which, when the transport gas is switched to open again, leads to a rapid pressure increase taking place in the atomiser (printing system) and consequently the aerosol production being accelerated. When the transport gas is connected to the atmosphere, the result, when connected again, is a useable aerosol jet only after a fairly long delay.

In order to prevent simultaneous suction of the aerosol in the gas separator 4 when the transport gas is switched off, the gas suction of the gas separator 4 is interrupted in addition at the same time. This takes place with the help of a 5/2-way valve 5. The suction unit is connected to the atmosphere since closure of the vacuum connection could lead to damage to the vacuum pump 6. The printing is effected via the printing head 7.

### Example 2

In FIG. 3, a line interruption is produced by the focusing gas being increased in the printing head 7 and hence the aerosol flow being prevented. For this purpose, a second nitrogen line is connected directly to the printing head. A 5/2-way valve 2 is connected intermediately to the line for increasing the volume flow. The valve 2 is connected such that the additional focusing gas can flow out freely during printing and no collection pressure is formed in the supply line and the printed image is not influenced. In the case of a desired interruption, the freely flowing gas into the printing head and the focusing gas is increased, which leads to a line interruption in the printed image. In order to avoid an increase in pressure outside the printing head 7 and feedback to the controller 3, a non-return valve 8 is incorporated in the supply line of the focusing gas. Furthermore, the system has a fine throttle valve 9. In the described example, the adjusted gas flow quantities are as follows:
Atomiser/transport gas 2,500 ml/min
Removal by suction in the gas separator 2,250 ml/min
Focusing gas 1,00 ml/min
   Additional focusing gas for interruption:
   1,500 ml/min

1-20. (canceled)

21. An aerosol printer, comprising at least one atomising chamber and at least one printing head with at least one nozzle, which are connected directly or via connection lines, and also process gas-, transport gas- and focusing gas lines, wherein at least one of the gas- or connection lines or the printing head have at least one device for reducing or increasing the gas- or aerosol throughflow for interrupting the aerosol transport from the atomising chamber to the nozzle.

22. The aerosol printer according to claim 21, wherein the device for reducing or increasing the gas- or aerosol throughflow is selected from the group consisting of pressure control valves, multiway valves, pressure regulating valves, throughput control valves, cut-off valves, flow governors, shutters or combinations hereof.

23. The aerosol printer according to claim 21, wherein for concentration of the aerosol, the connection line from the atomising chamber to the printing head is interrupted by a gas separator having a first and a second nozzle.

24. The aerosol printer according to claim 23, wherein the aerosol printer has in addition a vacuum pump for suctioning-off the gas which is integrated via a suction line, the suction line having a valve for interrupting the gas flow or a ventilation valve.

25. The aerosol printer according to claim 21, wherein the process gas line has a valve for interrupting or diverting the process gas.

26. The aerosol printer according to claim 21, wherein the process gas line is divided into a transport gas line and a focusing gas line and the transport gas line has a valve for interrupting or diverting the transport gas.

27. The aerosol printer according to claim 23, wherein the connection line between atomising chamber and gas separator has a valve for interrupting or diverting the aerosol flow or a shutter.

28. The aerosol printer according to claim 23, wherein the connection line between gas separator and printing head has a valve for interrupting or diverting the aerosol flow or a shutter.

29. The aerosol printer according to claim 23, wherein the gas separator has a bypass line and in that the bypass line has a valve for interrupting the gas flow or a ventilation valve.

30. The aerosol printer according to claim 21, wherein the focusing gas line has a device for increasing the gas throughflow, via which the gas flow of the focusing gas is increased relative to the gas flow of the transport gas such that the aerosol transport to the nozzle is interrupted.

31. The aerosol printer according to claim 21, wherein the printer has a plurality of nozzles.

32. The aerosol printer according to claim 21, wherein the atomiser is a pneumatic atomiser or an ultrasonic atomiser.

33. A method for producing line interruptions with a continuous aerosol printing method, utilizing an aerosol printer according to claim 21, in which a brief interruption to the aerosol transport is effected by specific adjustment of the gas pressure in the gas- or connection lines and/or in the printing head, with the help of at least one device for reducing or increasing the gas- or aerosol throughflow in order to interrupt the aerosol transport from the atomising chamber to the nozzle.

34. The method according to claim 33, wherein the gas pressure for the supply line of the focusing gas is increased such that, because of the substantially higher gas pressure of the focusing gas relative to the gas pressure of the transport gas, the aerosol transport to the nozzle is interrupted.

35. The method according to claim 33, wherein the gas pressure for the process gas line or the transport gas line is reduced, in particular by diversion of the gases via a multiway valve or using a pressure control valve, such that the aerosol transport from the atomising chamber to the nozzle is interrupted.

36. The method according to claim 33, wherein a brief pressure reduction is produced with the help of ventilation valves in the gas-, connection lines, in the printing head and/or in the gas separator, by means of which pressure reduction the aerosol transport to the nozzle is prevented.

37. The method according to claim 36, wherein the gas separator is switched off during the reduction in gas pressure.

38. The method according to claim 33, wherein the aerosol transport is interrupted by means of a shutter which is disposed in particular in the transport direction of the aerosol after the atomising chamber, after the gas separator or in the printing head.

39. The method according to claim 33, wherein the aerosol transport to all the nozzles in parallel is prevented when using a printer with a plurality of nozzles.

40. A method of printing metal contacts on solar cells or other semiconductors, utilizing an aerosol printer according to claim 21, in which a brief interruption to the aerosol transport is effected by specific adjustment of the gas pressure in the gas- or connection lines and/or in the printing head, with the help of at least one device for reducing or increasing the gas- or aerosol throughflow in order to interrupt the aerosol transport from the atomising chamber to the nozzle.
